(19) United States
(12) Patent Application Publication
(10) Pub. No.: US 2021/0001162 A1
(43) Pub. Date: Jan. 7, 2021

(54) Sprinkler with Flexible Body

(71) Applicant: Victaulic Company, Easton, PA (US)

(72) Inventors: Charles Oakes, Falls of Rough, KY (US); Michael J. Davis, Kunkletown, PA (US); Robert J. Ballard, Whitehall, PA (US)

(21) Appl. No.: 16/916,289

(22) Filed: Jun. 30, 2020

Related U.S. Application Data
(60) Provisional application No. 62/870,102, filed on Jul. 3, 2019.

(51) Int. Cl. A62C 35/68; A62C 31/02; A62C 31/28; B05B 1/26

(52) U.S. Cl. CPC A62C 35/68; B05B 1/265; A62C 31/28; A62C 31/02

(57) ABSTRACT

A sprinkler with flexible body for fire suppression includes a sprinkler head. An adapter extends from the sprinkler head and a flexible conduit extends from the adapter. The conduit is connectable to a source of fire suppressing liquid. The sprinkler with flexible body has a composite K factor indicative of the discharge flow rate from a discharge opening defined by the sprinkler head and can be directly substituted for a sprinkler having the same K factor with no change in the hydraulic characteristics of the fire suppression system in which the sprinkler with flexible body is integrated. An embodiment without the adapter, wherein the flexible conduit extends from the sprinkler head, is also feasible.

### CROSS REFERENCE TO RELATED APPLICATION

This application is based upon and claims benefit of priority to U.S. Provisional Application No. 62/870,102, filed Jul. 3, 2019 and hereby incorporated by reference herein.

### FIELD OF THE INVENTION

This invention relates to components for fire suppression systems.

### BACKGROUND

Various codes and standard governing the fire protection industry, and the installation of fire protection sprinklers in particular, create limitations on what components can be installed. In particular, fire sprinklers are rated with a K factor that is a measure of the amount of water a sprinkler can deliver at a given pressure. K factors are defined by the formula K=q/√p, where q=flow rate in GPM, and p=pressure in PSI. K factors range from about 2.8 to about 34, with K factors of about 3.6-8.0 being common in residential and light commercial applications.

In order to assure that the water pressure at each individual sprinkler head is sufficient to provide the required minimum flow rates, contractors often have to perform calculations of pressure loss due to the friction in the pipes to assure adequate pressure at each head. Smaller pipes come at less cost but have higher frictional losses. Larger pipes are more expensive, and may require increased size and capacity of other devices, such as pumps. Contractors therefore size pipe appropriate to the building requirements. In renovations work particularly, often called tenant improvement work, it is sometimes desirable to move sprinklers or attach them via flexible drops. Such flexible drops have friction loss characteristics associated with them, and there is a pressure drop between their inlet and the outlet where the sprinkler head is ultimately connected.

In order to assure adequate pressure at the head, many codes and standards require that the contractor perform a full recalculation of the system to account for the frictional losses in the flexible hose. Depending on jurisdiction, some areas do not require recalculation if only a small number of sprinkler heads are relocated.

Where recalculation is required however, it is often complicated and expensive. The government or authority plan review may take a long time and engineering review may be expensive. Further complicating issues include the fact that previous design or system information may not be available, whether lost, never completed, misplaced or otherwise missing. There may also be difficulty with running pressure and flow tests on the highest floor of an office building that needs to be retrofitted.

Such recalculation would not be required if the sprinkler was affixed directly to the existing network of pipes, without the intervening flexible hose. There is therefore a need for a product and a method of construction that allows renovation work to take advantage of the benefits of flexible hoses without introducing the need to recalculate the system hydraulic characteristics.

### SUMMARY

The invention concerns a sprinkler with a flexible body attachable to a source of fire suppressing liquid. In an example embodiment the sprinkler with flexible body comprises a sprinkler head which defines a discharge opening. A deflector is mounted on the sprinkler head in spaced relation to the discharge opening. An adapter extends from the sprinkler head. The adapter defines a bore in fluid communication with the discharge opening. A flexible conduit extends from the adapter. The flexible conduit is in fluid communication with the bore of the adapter. The flexible conduit has an inlet end attachable to the source of fire suppressing liquid. The fire suppressing liquid is discharged from the discharge opening at a flow rate defined by a composite K factor which includes pressure losses from the flexible conduit, the adapter and the sprinkler head. The K factor is defined as a ratio of the flow rate divided by a square root of a fluid pressure at the discharge opening.

By way of example, in the sprinkler with flexible body according to the invention, the discharge opening has a diameter sized in relation to one or more characteristics of the flexible conduit to provide a desired flow rate. In an example embodiment, the characteristics of the flexible conduit may include conduit length, conduit inner diameter, conduit inner surface roughness and combinations thereof. Further by way of example, the discharge opening may have a diameter sized in relation to one or more characteristics of the adapter to provide a desired flow rate. In an example embodiment the characteristics of the adapter include adapter length, adapter inner diameter, adapter inner surface roughness and combinations thereof.

In an example embodiment a nozzle is integrally formed with the sprinkler head. The nozzle includes the discharge opening and has an intake in fluid communication with the adapter. Further by way of example, the inlet end of the flexible conduit may comprise a flow conditioning device including a venturi or an orifice. In an example embodiment the sprinkler head is permanently attached to the adapter. Specifically by way of example, the sprinkler head is integrally formed with the adapter, for example, the sprinkler head and the adapter are cast as a unitary piece. Also by way of example, the sprinkler head may be permanently attached to the adapter by a method including welding, brazing, swaging and crimping.

In an example embodiment the flexible conduit comprises a corrugated hose. The flexible conduit is permanently attached to the adapter in an example. In an example embodiment the sprinkler head is integrally formed with the adapter. In another example embodiment the flexible conduit is permanently attached to the adapter by a method including welding, brazing, swaging and crimping.

Further by way of example, the sprinkler with flexible body may comprise a tamper evident seal extending between the sprinkler head and a portion of the adapter. In a specific example, the tamper evident seal may comprise a cover overlying a portion of the sprinkler head and the portion of the adapter. In another example embodiment, a tamper evident seal extends between a portion of the flexible conduit and a portion of the adapter. In a specific example, the tamper evident seal comprises a cover overlying the portion of the flexible conduit and the portion of the adapter.

The invention further encompasses a sprinkler with flexible body attachable to a source of fire suppressing liquid. In an example embodiment, the sprinkler with flexible body comprises a sprinkler head defining a discharge opening. A deflector is mounted on the sprinkler head in spaced relation to the discharge opening. A flexible conduit extends from the sprinkler head in fluid communication with the discharge opening. The flexible conduit has an inlet end attachable to the source of fire suppressing liquid. The fire suppressing liquid is discharged from the discharge opening at a flow rate defined by a composite K factor which includes pressure losses from the flexible conduit and the sprinkler head. The K factor is defined as a ratio of the flow rate divided by a square root of a fluid pressure at the discharge opening.

In an example embodiment, the discharge opening has a diameter sized in relation to one or more characteristics of the flexible conduit to provide a desired flow rate. The characteristics of the flexible conduit may include conduit length, conduit inner diameter, conduit inner surface roughness and combinations thereof. A nozzle may be integrally formed with the sprinkler head. The nozzle includes the discharge opening and has an intake in fluid communication with the flexible conduit. Further by way of example, the inlet end of the flexible conduit may comprise a flow conditioning device including a venturi or an orifice.

In an example embodiment the sprinkler head is permanently attached to the flexible conduit. In a specific example embodiment, the sprinkler head is integrally formed with the flexible conduit. Further by way of example, the sprinkler head is permanently attached to the adapter by a method including welding, brazing, swaging and crimping.

In an example embodiment the flexible conduit comprises a corrugated hose. A tamper evident seal may extend between the sprinkler head and a portion of the flexible conduit. By way of example the tamper evident seal may comprise a cover overlying a portion of the sprinkler head and the portion of the flexible conduit.

### BRIEF DESCRIPTION OF THE DRAWINGS

FIG. 1 is an isometric view of an example embodiment of a sprinkler with flexible body according to the invention;

FIG. 2 is a longitudinal sectional view of the sprinkler with flexible body shown in FIG. 1;

FIGS. 3 and 4 are longitudinal sectional views of portions of example embodiments of a sprinkler with flexible body according to the invention;

FIG. 5 is a longitudinal sectional view of a portion of an example embodiment of a sprinkler with flexible body according to the invention;

FIG. 6 is a partial exploded side view of a portion of an example sprinkler with flexible body according to the invention;

FIG. 7 is an isometric view of another example embodiment of a sprinkler with flexible body according to the invention;

FIG. 8 is a longitudinal sectional view of a portion of the sprinkler with flexible body shown in FIG. 7; and

FIG. 9 is a side view of a portion of an example sprinkler with flexible body according to the invention.

### DETAILED DESCRIPTION

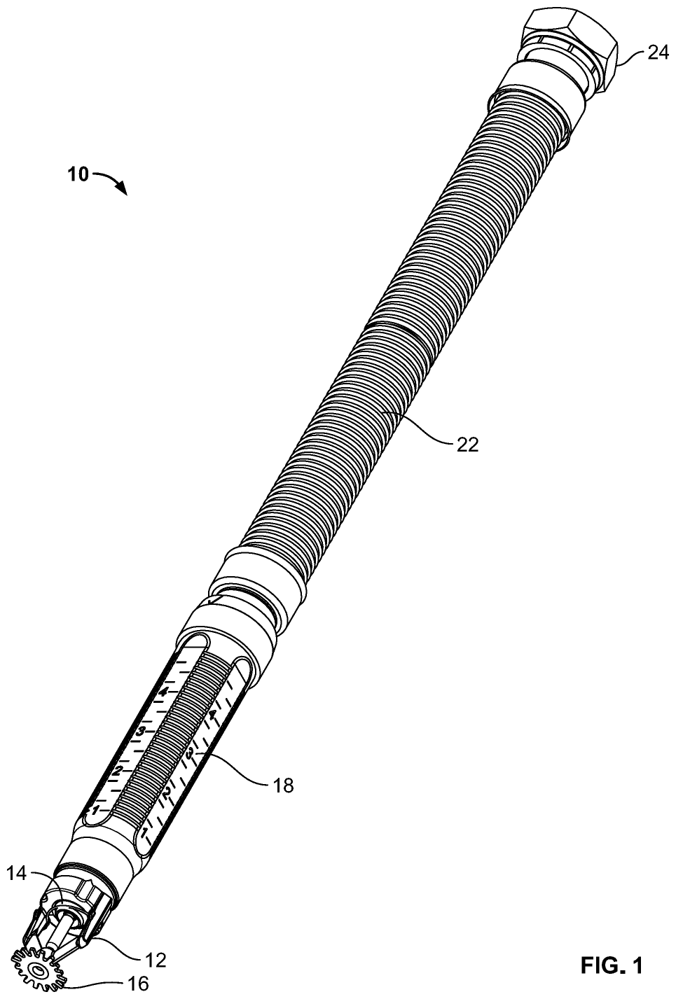

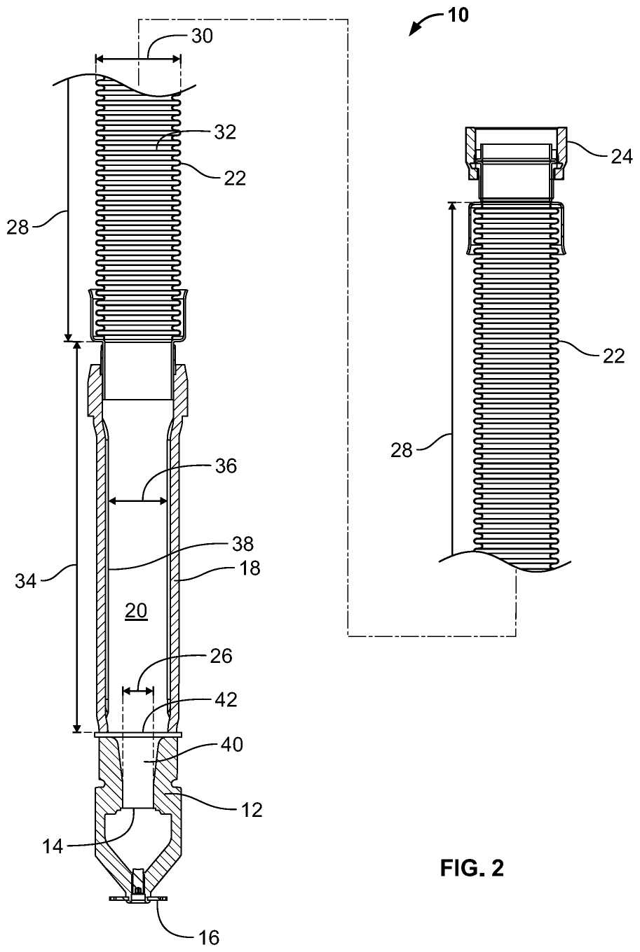

FIG. 1 shows an example embodiment of a sprinkler with flexible body 10 which is attachable to a source of fire suppressing liquid, such as the piping network of a fire suppression system (not shown). The example sprinkler with flexible body 10 comprises a sprinkler head 12. As shown in FIGS. 1 and 2, the sprinkler head 12 defines a discharge opening 14. A deflector 16 is mounted on the sprinkler head in spaced relation to the discharge opening. In this embodiment an adapter 18 extends from the sprinkler head. Adapter 18 defines a bore 20 in fluid communication with the discharge opening 14. A flexible conduit 22 extends from the adapter 18. Flexible conduit 22 is in fluid communication with the bore 20 of the adapter 18. The flexible conduit has an inlet end 24 attachable to the source of fire suppressing liquid.

The rate at which fire suppressing liquid is discharged from a sprinkler head is proportional to the sprinkler head's “K” factor where K is the ratio of the flow rate divided by the square root of the fluid pressure at the discharge opening: K=q/√p. In the United States, K is calculated using q (flow rate) in gallons per minute (gal/min) and p (discharge or nozzle pressure) in pounds per square inch (psi). The K factor is thus a numerical coefficient which captures the pressure loss characteristics of the sprinkler head as a function of flow rate. Generally in fire suppression technology, only sprinkler heads are rated in terms of their K factor. However, it is advantageous to measure and assign a composite K factor to the entire sprinkler with flexible body 10. Thus, during renovations work, an individual sprinkler head having a specified K factor can be replaced by a sprinkler with flexible body 10 having the same (composite) K factor as the original sprinkler. This obviates the need for any hydraulic calculations and allows a designer to preserve or even augment the flow rate of fire suppressing liquid as desired. The sprinkler head used with the sprinkler with flexible body 10 will have a larger discharge opening 14 than the individual sprinkler head it replaces to compensate for the larger pressure drop across the sprinkler with flexible body 10 due to the presence of the flexible conduit 22 and the adapter 18, which may add friction and turbulence to the flow with a concomitant pressure head loss.

In order to achieve a desired flow rate, the discharge opening 14 has a diameter 26 (see FIG. 2) sized in relation to one or more characteristics of the flexible conduit 22. The characteristics of the flexible conduit which are expected to affect flow rate include conduit length 28, conduit inner diameter 30, conduit inner surface roughness 32 and combinations thereof. It is further thought that characteristics of the adapter 18 will also affect flow rate. Thus the diameter 26 of the discharge opening 24 may also be sized in relation to one or more characteristics of the adapter 18 to provide a desired flow rate. These adapter characteristics may include adapter length 34, adapter inner diameter 36, adapter inner surface roughness 38 and combinations thereof. Additionally, the characteristics of the sprinkler head 12 may also be taken into account to size the discharge opening 14.

In one example, a sprinkler with flexible body according to the invention and having a K-factor of k=5.6 may have a diameter 26 greater than 0.445″ and advantageously greater than 0.455″, while also having a conduit length from about 48″ to about 72″ and preferentially from about 56″ to about 62″.

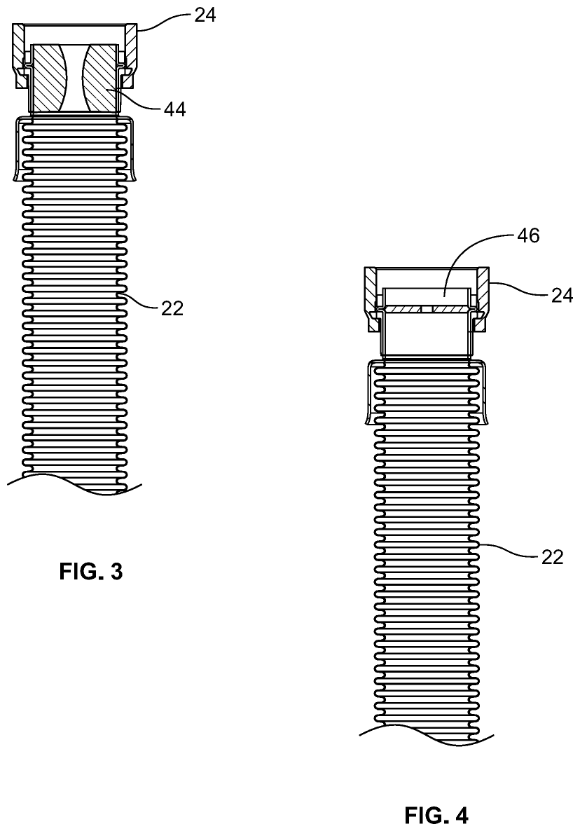

It may be further advantageous to include flow conditioning devices in the sprinkler with flexible body 10. Flow conditioning devices may be used to reduce turbulence within the flexible conduit 22 and the adapter 18 and may take the form of a nozzle 40 integrally formed with the sprinkler head 12. In this example the nozzle 40 includes the discharge opening 14 and has an intake 42 in fluid communication with the adapter 18. As shown in FIGS. 3 and 4, further flow conditioning devices may include a venturi 44 (FIG. 3) and/or and orifice 46 (FIG. 4) located at or near the inlet end 24 of the flexible conduit 22. As these flow conditioning devices may also affect the discharge rate, the diameter 26 of the discharge opening 14 may be sized to take them into account as well as other factors.

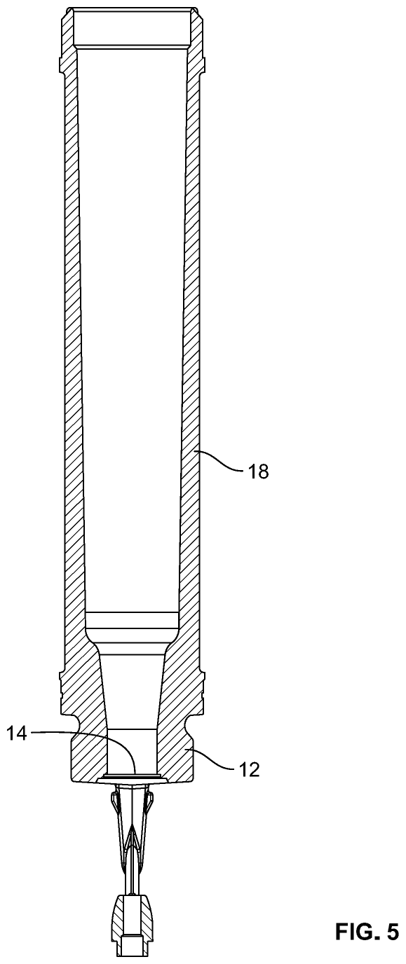

To preserve the hydraulic integrity of the composite K factor as it is associated with a particular sprinkler with flexible body 10, it is advantageous to permanently attach the sprinkler head 12 to the adapter 18, as well as to permanently attach the adapter to the flexible conduit 22. The term “permanently attach” means to attach the sprinkler head and adapter and the adapter and flexible conduit such that the parts are not easily separated. Permanent attachment of the sprinkler head 12 to the adapter 18 is conveniently achieved by integrally forming the sprinkler head with the adapter, for example, by casting the sprinkler head 12 and the adapter 18 as a unitary piece as shown in FIG. 5. As brass is a preferred material for sprinkler heads, integrally casting both the sprinkler head and the adapter is practical. However, when the components comprising the sprinkler with flexible body 10 are of different materials, integral casting is not an option. For example, a practical design for the sprinkler with flexible body 10 will have a brass sprinkler head 12, a carbon steel alloy or ductile iron adapter 18 and a flexible conduit 22 comprising a corrugated hose of stainless steel (see FIGS. 1 and 2). In such a design the sprinkler head 12 may be permanently attached to the adapter 18 by one of a number of methods including welding, brazing, swaging and crimping. A further impediment to disassembly is the elimination of a wrench boss on the sprinkler head 12 if threaded connections to the adapter 18 are used. Similarly, the flexible conduit 22 may also be permanently attached to the adapter 18 by methods including welding, brazing, swaging and crimping. Permanent attachment is advantageous because the sprinkler with flexible body 10 is meant to comprise a preassembled unit, not intended to be disassembled by the user for installation, repair or replacement. The permanence of the component attachments preserves the hydraulic integrity of the unit and ensures that the K factor is not changed by an alteration to the design.

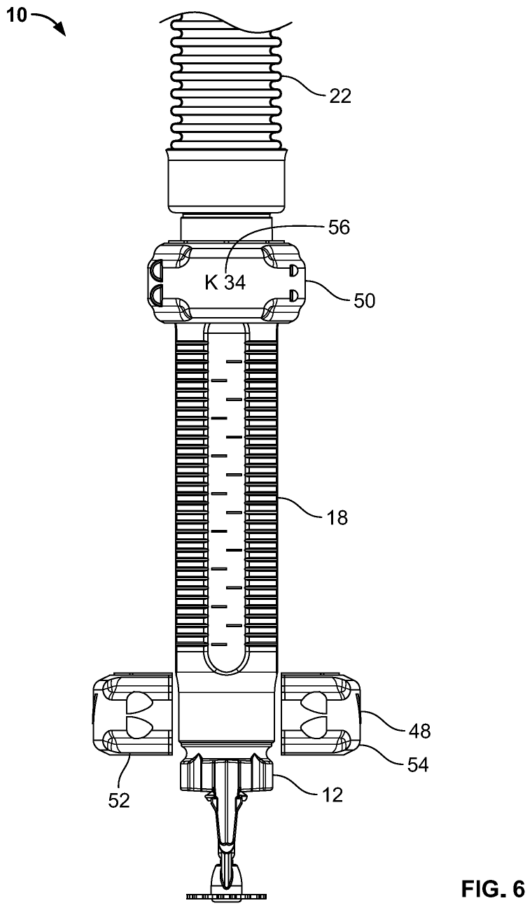

As shown in FIG. 6, tamper evident seals 48 and 50 may be used to further safeguard the hydraulic integrity of the sprinkler with flexible body 10. In this example embodiment, seal 48 comprises a cover extending between and overlying a portion of the sprinkler head 12 and a portion of the adapter 18, and seal 50 comprises a cover extending between and overlying a portion of the flexible conduit 22 and a portion of the adapter 18. In this example, tamper evident seals 48 and 50 comprise segments 52 and 54 of relatively high-strength, brittle plastic polymer which lock together when positioned on the sprinkler with flexible body 10 and must be broken to be removed, a broken seal indicating evidence of potential tapering. Indicia 56 may also be placed on the outer surfaces of the seals 48 and 50 to warn users not to disassemble the sprinkler with flexible body 10 as well as to indicate its (composite) K factor.

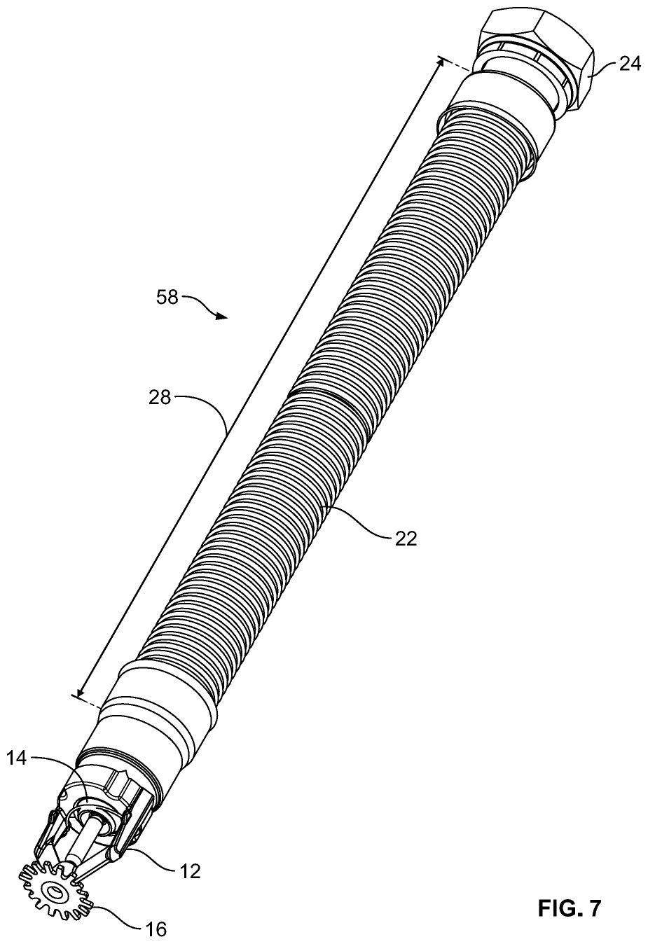

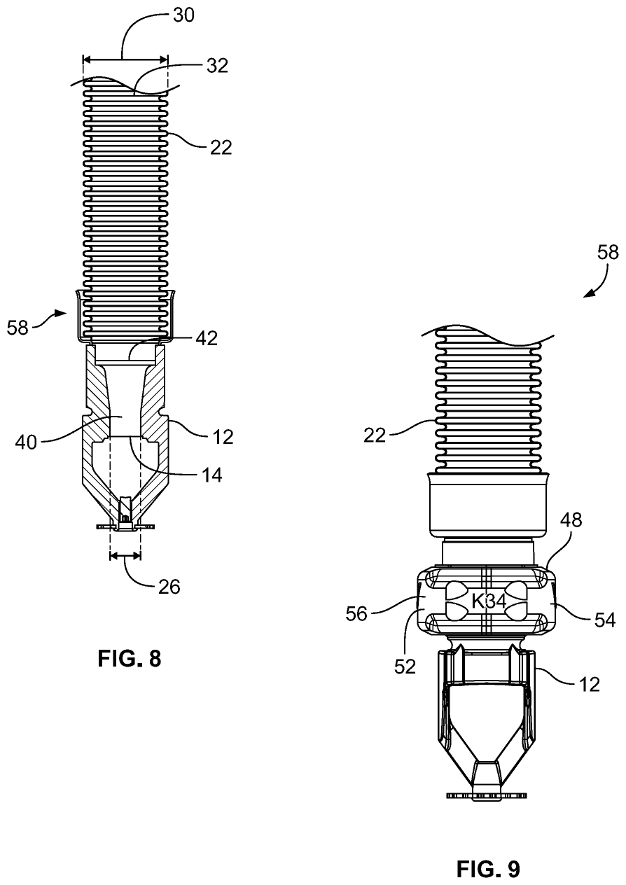

FIG. 7 shows another example embodiment of a sprinkler with flexible body 58 according to the invention. Embodiment 58 differs from embodiment 10 in that the adapter 18 is eliminated. An example sprinkler with flexible body 58 thus comprises a sprinkler head 12 defining a discharge opening 14. A deflector 16 is mounted on the sprinkler head in spaced relation to the discharge opening. A flexible conduit 22 extends from the sprinkler head 12 and is in fluid communication with the discharge opening 14. The flexible conduit 22 has an inlet end 24 attachable to a source of fire suppressing liquid. The fire suppressing liquid is discharged from the discharge opening 14 at a flow rate defined by a composite K factor which includes pressure losses from the flexible conduit 22 and the sprinkler head 12. The K factor is defined as a ratio of the flow rate divided by a square root of a fluid pressure at the discharge opening 14. The diameter 26 of discharge opening 14 (see FIG. 8) is sized in relation to one or more characteristics of the flexible conduit 22 to provide a desired flow rate. The characteristics of the flexible conduit 22 used to determine diameter 26 include conduit length 28 (FIG. 7), conduit inner diameter 30 (FIG. 8), conduit inner surface roughness 32 and combinations thereof.

The sprinkler with flexible body 58 may also include flow conditioning devices such as a nozzle 40 integrally formed with the sprinkler head 12. Nozzle 40 includes the discharge opening 14 and an intake 42 in fluid communication with the flexible conduit 22. As shown in FIGS. 3 and 4, the inlet end 24 of the flexible conduit 22 may further comprise a flow conditioning device, for example, a venturi 44 or an orifice 46.

To preserve the hydraulic integrity of the sprinkler with flexible body 58, the sprinkler head 12 is permanently attached to the flexible conduit 22. This permanent attachment may be effected integrally forming the sprinkler head 12 with the flexible conduit 22 or by attachment methods including welding, brazing, swaging and crimping. It is considered advantageous to form the sprinkler head 12 from brass and the flexible conduit from a corrugated hose of stainless steel.

As shown in FIG. 9, a tamper evident seal 48 may be used to further safeguard the hydraulic integrity of the sprinkler with flexible body 58. In this example embodiment, seal 48 comprises a cover extending between and overlying a portion of the sprinkler head 12 and a portion of the flexible conduit 22. In this example, tamper evident seal 48 comprises segments 52 and 54 of relatively high-strength, brittle plastic polymer which lock together when positioned on the sprinkler with flexible body 58 and must be broken to be removed, a broken seal indicating evidence of potential tapering. Indicia 56 may also be placed on the outer surfaces of the seal 48 to warn users not to disassemble the sprinkler with flexible body 10 as well as to indicate its (composite) K factor.

For either embodiment of the sprinkler with flexible body, flowrate testing to determine the actual K factor is performed on the entire unit, namely, the flexible conduit, adapter and sprinkler head for embodiment 10, and the flexible conduit and sprinkler head for embodiment 58 along with any flow conditioning devices which may be present. For any give K factor, the diameter 26 of the discharge opening 14 of the sprinkler head 12 will be larger that it would otherwise be if the sprinkler head were not part of a flexible body (e.g., flexible conduit 22) or a flexible body and an adapter. The diameter 26 of the discharge opening 14 is expected to be the minimum diameter of the sprinkler head 12 as well as the minimum diameter of the entire unit which comprises the sprinkler with flexible body.

Sprinkler with flexible body as disclosed in embodiments 10 and 58 having a composite K factor according to the invention are expected to provide significant benefit in renovation work as well as new construction and are further considered an improvement in fire safety.

What is claimed is:

1. A sprinkler with flexible body attachable to a source of fire suppressing liquid, said sprinkler with flexible body comprising:
a sprinkler head defining a discharge opening, a deflector mounted on said sprinkler head in spaced relation to said discharge opening;
an adapter extending from said sprinkler head, said adapter defining a bore in fluid communication with said discharge opening;
a flexible conduit extending from said adapter, said flexible conduit being in fluid communication with said bore of said adapter, said flexible conduit having an inlet end attachable to said source of fire suppressing liquid, wherein
said fire suppressing liquid is discharged from said discharge opening at a flow rate defined by a composite K factor which includes pressure losses from said flexible conduit, said adapter and said sprinkler head, said K factor defined as a ratio of said flow rate divided by a square root of a fluid pressure at said discharge opening.

2. The sprinkler with flexible body according to claim 1, wherein said discharge opening has a diameter sized in relation to one or more characteristics of said flexible conduit to provide a desired flow rate.

3. The sprinkler with flexible body according to claim 2, wherein said characteristics of said flexible conduit include conduit length, conduit inner diameter, conduit inner surface roughness and combinations thereof.

4. The sprinkler with flexible body according to claim 1, wherein said discharge opening has a diameter sized in relation to one or more characteristics of said adapter to provide a desired flow rate.

5. The sprinkler with flexible body according to claim 4, wherein said characteristics of said adapter include adapter length, adapter inner diameter, adapter inner surface roughness and combinations thereof.

6. The sprinkler with flexible body according to claim 1 further comprising a nozzle integrally formed with said sprinkler head, said nozzle including said discharge opening and having an intake in fluid communication with said adapter.

7. The sprinkler with flexible body according to claim 1, wherein said inlet end of said flexible conduit comprises a flow conditioning device including a venturi or an orifice.

8. The sprinkler with flexible body according to claim 1, wherein said sprinkler head is permanently attached to said adapter.

9. The sprinkler with flexible body according to claim 8, wherein said sprinkler head is integrally formed with said adapter.

10. The sprinkler with flexible body according to claim 9, wherein said sprinkler head and said adapter are cast as a unitary piece.

11. The sprinkler with flexible body according to claim 8, wherein said sprinkler head is permanently attached to said adapter by a method including welding, brazing, swaging and crimping.

12. The sprinkler with flexible body according to claim 1, wherein said flexible conduit comprises a corrugated hose.

13. The sprinkler with flexible body according to claim 1, wherein said flexible conduit is permanently attached to said adapter.

14. The sprinkler with flexible body according to claim 13, wherein said sprinkler head is integrally formed with said adapter.

15. The sprinkler with flexible body according to claim 13, wherein said flexible conduit is permanently attached to said adapter by a method including welding, brazing, swaging and crimping.

16. The sprinkler with flexible body according to claim 1, further comprising a tamper evident seal extending between said sprinkler head and a portion of said adapter.

17. The sprinkler with flexible body according to claim 16, wherein said tamper evident seal comprises a cover overlying a portion of said sprinkler head and said portion of said adapter.

18. The sprinkler with flexible body according to claim 1, further comprising a tamper evident seal extending between a portion of said flexible conduit and a portion of said adapter.

19. The sprinkler with flexible body according to claim 18, wherein said tamper evident seal comprises a cover overlying said portion of said flexible conduit and said portion of said adapter.

20. A sprinkler with flexible body attachable to a source of fire suppressing liquid, said sprinkler with flexible body comprising:
a sprinkler head defining a discharge opening, a deflector mounted on said sprinkler head in spaced relation to said discharge opening;
a flexible conduit extending from said sprinkler head in fluid communication with said discharge opening, said flexible conduit having an inlet end attachable to said source of fire suppressing liquid, wherein
said fire suppressing liquid is discharged from said discharge opening at a flow rate defined by a composite K factor which includes pressure losses from said flexible conduit and said sprinkler head, said K factor defined as a ratio of said flow rate divided by a square root of a fluid pressure at said discharge opening.

21. The sprinkler with flexible body according to claim 20, wherein said discharge opening has a diameter sized in relation to one or more characteristics of said flexible conduit to provide a desired flow rate.

22. The sprinkler with flexible body according to claim 21, wherein said characteristics of said flexible conduit include conduit length, conduit inner diameter, conduit inner surface roughness and combinations thereof.

23. The sprinkler with flexible body according to claim 20, further comprising a nozzle integrally formed with said sprinkler head, said nozzle including said discharge opening and having an intake in fluid communication with said flexible conduit.

24. The sprinkler with flexible body according to claim 20, wherein said inlet end of said flexible conduit comprises a flow conditioning device including a venturi or an orifice.

25. The sprinkler with flexible body according to claim 20, wherein said sprinkler head is permanently attached to said flexible conduit.

26. The sprinkler with flexible body according to claim 25, wherein said sprinkler head is integrally formed with said flexible conduit.

27. The sprinkler with flexible body according to claim 25, wherein said sprinkler head is permanently attached to said adapter by a method including welding, brazing, swaging and crimping.

28. The sprinkler with flexible body according to claim 20, wherein said flexible conduit comprises a corrugated hose.

29. The sprinkler with flexible body according to claim 20, further comprising a tamper evident seal extending between said sprinkler head and a portion of said flexible conduit.

30. The sprinkler with flexible body according to claim 29, wherein said tamper evident seal comprises a cover overlying a portion of said sprinkler head and said portion of said flexible conduit.
